(19) United States
(12) Patent Application Publication
(10) Pub. No.: US 2015/0326026 A1
(43) Pub. Date: Nov. 12, 2015

(54) WIRELESS SOUND POWERING OF ELECTRONIC DEVICES WITH SELECTIVE DELIVERY RANGE

(71) Applicant: Energous Corporation, San Jose, CA (US)

(72) Inventor: Michael A. Leabman, Pleasanton, CA (US)

(21) Appl. No.: 14/273,253

(22) Filed: May 8, 2014

(51) Int. Cl. H02J 5/00; H02J 17/00; H02J 7/02

(52) U.S. Cl. CPC H02J 5/005; H02J 7/025; H02J 17/00

(57) ABSTRACT

The present disclosure describes a methodology for wireless sound power transmission based on pocket-forming. This methodology may include one transmitter and at least one or more receivers, being the transmitter the sender of energy and the receiver connected to an electronic device that is desired to charge or power. The transmitters power devices within a predefined range. This configuration may be beneficial in retail store settings where improved interactivity between users and devices is required. In addition, the configuration provides a safety feature to avoid unauthorized usage of electronic devices. A variation of this configuration is given in an academic setting where electronic devices utilized for learning are required to stay within school premises.

### CROSS-REFERENCES TO RELATED APPLICATIONS

The present disclosure is related to U.S. Non-Provisional patent application Ser. No. 13/891,430 filed May 10, 2013, entitled “Methodology For Pocket-forming”; Ser. No. 13/925,469 filed Jun. 24, 2013, entitled “Methodology for Multiple Pocket-Forming”; Ser. No. 13/946,082 filed Jul. 19, 2013, entitled “Method for 3 Dimensional Pocket-forming”; Ser. No. 13/891,399 filed May 10, 2013, entitled “Receivers for Wireless Power Transmission”; Ser. No. 13/891,445 filed May 10, 2013, entitled “Transmitters For Wireless Power Transmission” and Ser. No. 13/919,567 filed Jun. 17, 2013, entitled “Improved Battery Life of Portable Electronic Devices”, the entire contents of which are incorporated herein by these references.

### FIELD OF INVENTION

The present disclosure relates generally to wireless sound power transmission, and more particularly, to wireless sound power transmission through pocket-forming.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plugin to a wall or other power supply to be able to charge his or her electronic device. However, such an activity may render electronic devices inoperable during charging. Current solutions to this problem may include inductive pads which may employ magnetic induction or resonating coils. Nevertheless, such a solution may still require that electronic devices may have to be placed in a specific place for powering. Thus, electronic devices during charging may not be portable. For the foregoing reasons, there is a need for a wireless power transmission system where electronic devices may be powered without requiring extra chargers or plugs, and where the mobility and portability of electronic devices may not be compromised.

### SUMMARY OF THE INVENTION

The present disclosure describes a methodology for wireless sound power transmission based on pocket-forming. This methodology may include one transmitter and at least one or more receivers, being the transmitter the source of energy and the receiver connected to the electronic device that is desired to charge or power. Techniques for determining the location of electronic devices including receivers is disclosed herein.

In an embodiment, a description of pocket-forming methodology using at least one transmitter and at least one receiver may be provided.

In another embodiment, a transmitter suitable for pocket-forming including at least two transducer elements may be provided.

In a further embodiment, a receiver suitable for pocket forming including at least one sensor element may be provided.

In an embodiment, a wireless power transmission where a transmitter may provide wireless power to one or more electronic devices within a predefined range may be provided. For exemplification purposes, the embodiment deals with electronic devices for display in retail stores.

In an embodiment, a wireless power transmission where a transmitter may provide wireless sound power to one or more electronic devices within a predefined range may be provided. For exemplification purposes, the embodiment deals with electronic devices in academic settings where devices may be linked to one or more transmitters.

In a yet further embodiment, an improved rollable electronic paper display may be provided to exemplified advantages of electronic devices utilizing the disclosed wireless sound power transmission techniques. As a variation, an embodiment for an improved electronic reader may be provided.

### BRIEF DESCRIPTION OF THE DRAWINGS

Embodiments of the present disclosure are described by way of example with reference to the accompanying figures which are schematic and may not be drawn to scale. Unless indicated as representing the background information, the figures represent aspects of the present disclosure.

FIG. 1 illustrates wireless power transmission using pocket-forming, according to an embodiment.

FIG. 2 illustrates a component level illustration for a transmitter which may be utilized to provide wireless power transmission as described in FIG. 1, according to an embodiment.

FIG. 3 illustrates a component level embodiment for a receiver which can be used for powering or charging an electronic device as described in FIG. 1, according to an embodiment.

FIG. 4 illustrates a wireless power transmission where one or more electronic devices may receive power through a transmitter (as described from FIG. 1 through 3) at a predefined range, in a retail store setting, according to an embodiment.

FIG. 5 illustrates a wireless power transmission where one or more electronic devices may receive power through a transmitter (as described from FIG. 1 through 3) at a predefined range, in a school or academic setting, according to an embodiment.

FIG. 6 illustrates an improved rollable electronic paper display for explaining the advantages of the disclosed wireless power transmission when utilized for electronic devices.

### DETAILED DESCRIPTION OF THE DRAWINGS

### Definitions

“Pocket-forming” may refer to generating two or more sound waves which converge in 3-d space, forming controlled constructive and destructive interference patterns.

“Pockets of energy” may refer to areas or regions of space where energy or power may accumulate in the form of constructive interference patterns of sound waves.

“Null-space” may refer to areas or regions of space where pockets of energy do not form because of destructive interference patterns of sound waves (SW).

“Transmitter” may refer to a device, including a chip which may generate two or more SW signals, at least one SW signal being phase shifted and gain adjusted with respect to other SW signals, substantially all of which pass through one or more SW transducer such that focused SW signals are directed to a target.

“Receiver” may refer to a device including at least one sensor element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments can be used and/or and other changes can be made without departing from the spirit or scope of the present disclosure.

As background, a sound waveform has the same characteristics as that of an electrical waveform which are Wavelength (λ), Frequency (f) and Velocity (m/s). Both the sounds frequency and wave shape are determined by the origin or vibration that originally produced the sound but the velocity is dependent upon the medium of transmission (air, water etc.) that carries the sound wave. Audio Sound Transducers include both input sensors, that convert sound into and electrical signal such as a Microphone and output actuators that convert the electrical signals back into sound such as a loudspeaker that is essential for generating the adaptive pocket-forming

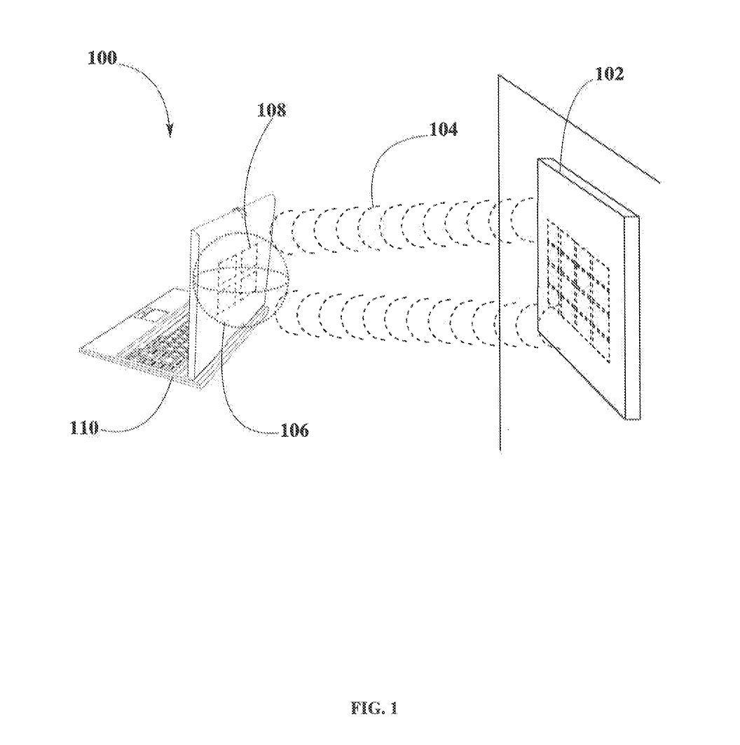

FIG. 1 illustrates wireless power transmission (WPT) 100 using pocket-forming. A transmitter 102 may transmit controlled sound waves 104 which may converge in 3-d space. These sound waves 104 may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy 106 produced by pocket-forming for charging or powering an electronic device, for example a laptop computer 110 and thus effectively providing wireless sound power transmission. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

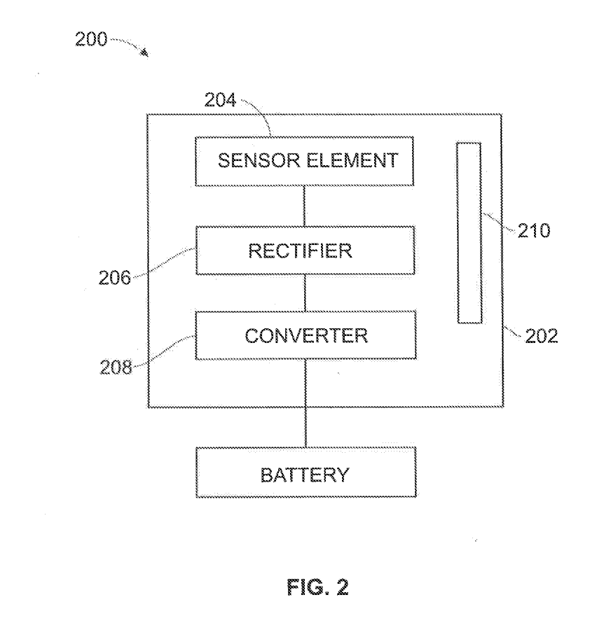

FIG. 2 illustrates a component level embodiment for a transmitter 200 which may be utilized to provide wireless power transmission 100 as described in FIG. 1. Transmitter 200 may include a housing 202 where at least two or more transducer elements 204, at least one SW integrated circuit (SWIC) 206, at least one digital signal processor (DSP) or micro-controller 208, and one optional communications component 210 may be included. Housing 202 can be made of any suitable material which may allow for signal or wave transmission and/or reception, for example plastic or hard rubber. Transducer elements 204 may include suitable transducer types for operating in frequency bands such as 10 KHz to 50 KHz as these frequency bands are ideally suited for sound transmission in wireless power transmission and configured to provide the required power sound waves for reception by the electronic device to be charged or powered. Transducer elements 204 may include piezoelectric transducers and similar such transducers capable of producing controlled sound waves that are directed to electronic device ready to be powered. Other transducer elements 204 types can be used, for example meta-materials, dipole among others. SWIC 206 may include a proprietary chip for adjusting phases and/or relative magnitudes of SW signals which may serve as inputs for transducer elements 204 for controlling pocket-forming. These SW signals may be produced using an external power supply 212 and a local oscillator chip (not shown) using a suitable piezoelectric material. Micro-controller 208 may then process information sent by a receiver through its own antenna element in communication circuitry 310 for determining optimum times and locations for pocket-forming. In some embodiments, the foregoing may be achieved through communications component 210. Communications component 210 may be based on standard wireless communication protocols which may include Bluetooth, Wi-Fi or ZigBee. In addition, communications component 210 may be used to transfer other information such as an identifier for the device or user, battery level, location or other such information. Other communications component 210 may be possible which may include radar, infrared cameras or sound devices for sonic triangulation for determining the device's position.

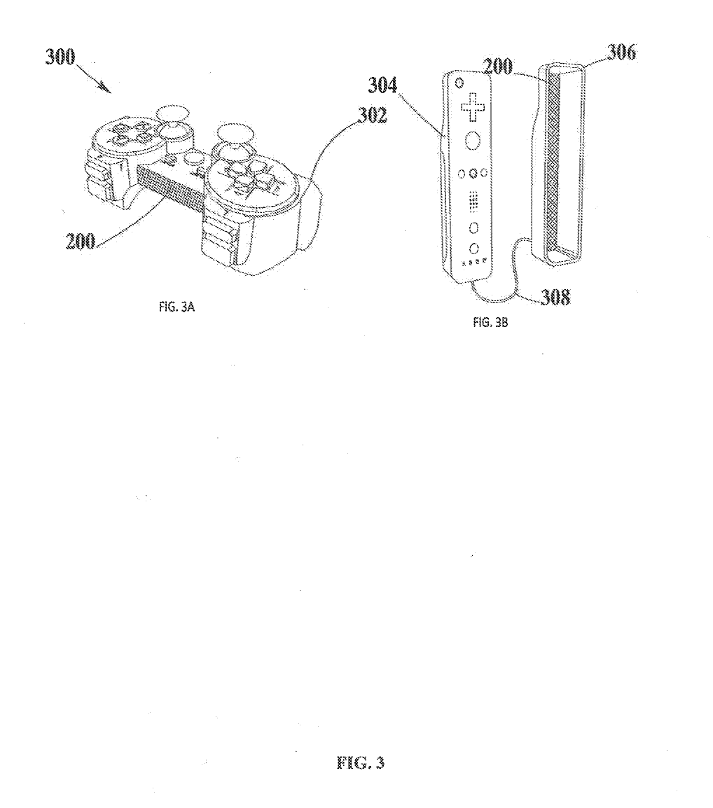

FIG. 3 illustrates a component level embodiment for a receiver 300 which can be used for powering or charging an electronic device as exemplified in wireless power transmission 100. Receiver 300 may include a housing 302 where at least one sensor element 304, one rectifier 306, one power converter 308 and an optional communications component 310 may be included. Housing 302 can be made of any suitable material which may allow for signal or wave transmission and/or reception, for example plastic or hard rubber. Housing 302 may be an external hardware that may be added to different electronic equipment, for example in the form of cases, or can be embedded within electronic equipment as well. Sensor element 304 may include suitable sensor types for operating in frequency bands similar to the bands described for transmitter 200 in FIG. 2.

Suitable sensor elements 304 are microphone types. A sound transducer that can be classed as a “sound sensor”. This is because it produces an electrical analogue output signal which is proportional to the “acoustic” sound wave acting upon its flexible diaphragm. This signal is an “electrical image” representing the characteristics of the acoustic waveform. Generally, the output signal from a microphone is an analogue signal either in the form of a voltage or current which is proportional to the actual sound wave. The most common types of microphones available as sound transducers are Dynamic, Electret Condenser, Ribbon and the newer Piezo-electric Crystal types. This may further prove advantageous as a receiver, such as receiver 300, where the sensor element 304 is a dynamic moving-coil microphone sound transducer to optimize wireless power transmission as well as suitable sensors for sound wave detection. Using multiple sensor elements 304 are beneficial in devices where there may not be a preferred orientation during usage or whose orientation may vary continuously through time, for example a smartphone or portable gaming system. On the contrary, for devices with well-defined orientations, for example a two-handed video game controller, there might be a preferred sensor arrangement which may dictate a ratio for the number of sensors of a given type.

This may further prove advantageous to a receiver, such as receiver 300, where a dynamic moving-coil microphone sound transducer microphone sound transducer is configured to pickup the power sound waves from the transmitter. The construction of a dynamic microphone resembles that of a loudspeaker to optimize wireless power transmission. Rectifier 306 may include diodes or resistors, inductors or capacitors to rectify the alternating current (AC) voltage generated by sensor element 304 to direct current (DC) voltage. Rectifier 306 may be placed as close as is technically possible to sensor element 304 to minimize losses. After rectifying AC voltage, DC voltage may be regulated using power converter 308. Power converter 308 can be a DC-DC converter which may help provide a constant voltage output, regardless of input, to an electronic device, or as in this embodiment to a battery 312. Typical voltage outputs can be from about 5 volts to about 10 volts. Lastly, communications component 310, similar to that of transmitter 200 from FIG. 2, may be included in receiver 300 to communicate with a transmitter or to other electronic equipment.

In some embodiments, an embedded receiver 300 may be used to power up one or more capacitors within a given electronic device, e.g. a smartphone, which upon discharging may provide sufficient power to the smartphone. The foregoing configuration may diminish the size and power capabilities of batteries included in the foregoing electronic devices. Moreover, depending on the capacitors' size and efficiency, batteries may not even be required in the aforementioned devices.

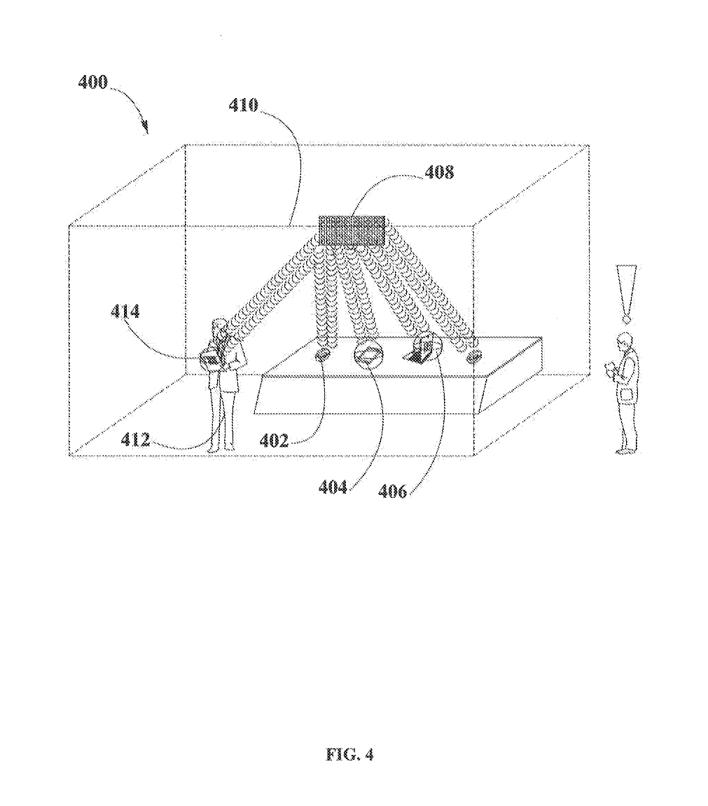

FIG. 4 illustrates a WPT 400 where various electronic devices, for example a smartphone 402, a tablet 404 and a laptop 406 may receive power, through pocket-forming, utilizing a transmitter 408 (as described from FIG. 1 through FIG. 3) at a predefined range 410. The aforementioned devices may include embedded receivers (or be otherwise operatively coupled to receivers) and capacitors for obtaining the necessary power for performing their intended functions (as described in FIG. 3 above). In this embodiment, capacitors included in the electronic devices may only provide charge storing capacity for powering the aforementioned electronic devices for a limited period of time, e.g. 5 minutes. Thus, such electronic devices may be required to stay within range 410 of transmitter 408 to be operable. This configuration of WPT 400 may be beneficial in retail stores where the interaction between electronic devices (used for showcase) and potential buyers may be limited due to the presence of wired connections. Typically, electronic devices which are showcased may be connected to wires for power and security issues. However, the foregoing may be eliminated by utilizing a scheme as the one disclosed in FIG. 4. For example, a potential buyer 412 may be interested in acquiring a tablet 414. Because tablet 414 employs no wires for display and receives power through pocket-forming, buyer 412 may interact freely with it as much as he wants, and with improved spatial mobility. However, were buyer 412 to step out of the range at which transmitter 408 delivers power, tablet 414 may no longer be operable (as can be seen in the rightmost part of FIG. 4). In addition, transmitter 408 may automatically detect that tablet 414 is outside its range, and may therefore issue an alarm.

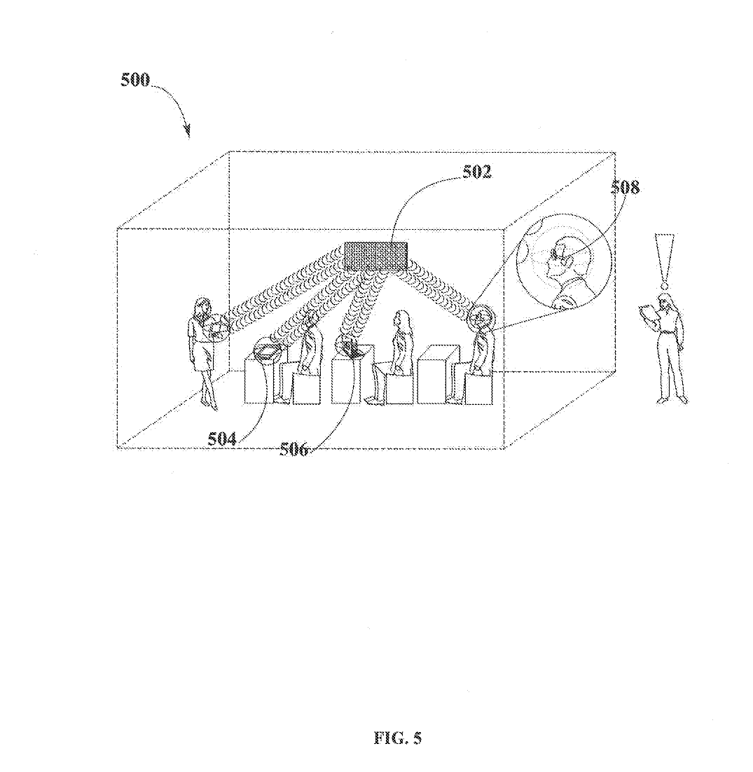

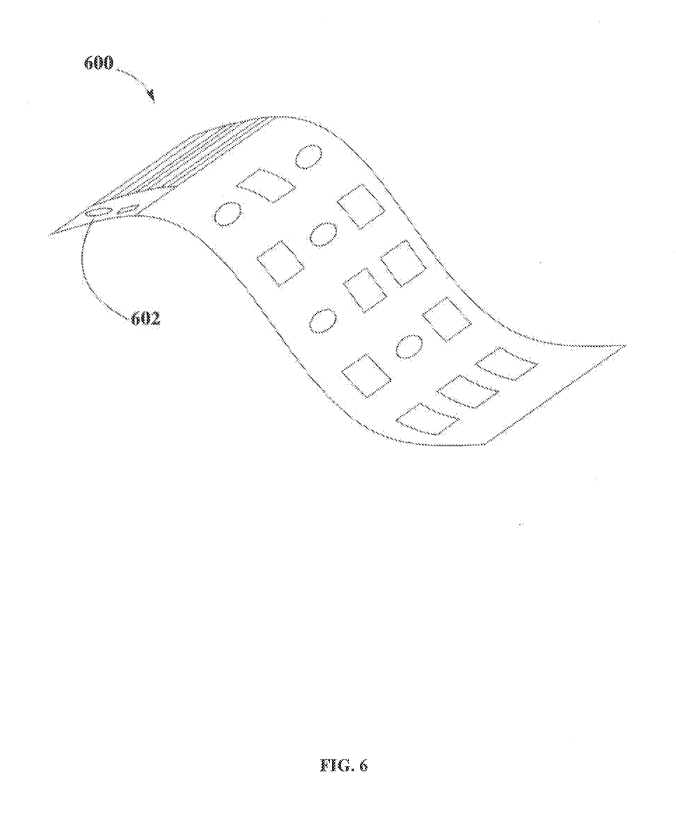

FIG. 5 illustrates an alternate WPT 500 as the one described in FIG. 4 above. In this embodiment, the powering scheme described in FIG. 4 can be applied to educational settings. For example, in educational programs for developing or unprivileged cities, regions and countries, teachers and students may be provided with tablets, electronic readers, laptops or even virtual glasses for imparting and taking notes during lectures. However, such equipment may be expensive. Therefore, measures for preventing unauthorized usage of such devices may be employed. For example, devices may be wired to school chairs so that they may not be taken outside classrooms. However, utilizing electronic devices with embedded receivers (as described in FIG. 3 and FIG. 4 above) may improve the foregoing situation. In an embodiment, a transmitter 502 inside a classroom may provide wireless power, through pocket-forming, to various electronic devices with embedded receivers and capacitors (not shown), for example an e-reader 504, a laptop 506 and virtual glasses 508 which may be used by different users. The foregoing electronic devices may become inoperable outside the range of transmitter 502, as can be seen in the rightmost part of FIG. 5. In some instances, the foregoing electronic devices may be linked only to transmitter 502, i.e. they may only receive power from transmitter 502. In other embodiments, electronic devices may be linked to all possible transmitters from a given school, i.e. electronic devices may only be usable in their intended classrooms or schools. In addition, certain properties of electronic devices may improve, for example, some devices may become lighter or thinner as less powerful or no batteries may be required. In some cases, the overall interaction of devices may be improved as can be seen in FIG. 6 below.

FIG. 6 illustrates an improved rollable electronic paper display 600. The foregoing devices are known in the art, and can typically be produced utilizing flexible organic light emitting diodes (FOLED). In this embodiment, rollable electronic paper display 600 may include at least one embedded receiver 602 with a capacitor in one of its corners. Thus, the circuitry for providing power to rollable electronic paper display 600 may be confined to only a fraction of its surface area. In turn, this may improve the transparency of rollable electronic paper display 600. In other embodiments, an e-reader including the aforementioned receivers and capacitors, may diminish its weight considerably, as well as improve its display brightness. Currently, the weight of e-readers may be driven by their batteries, e.g. up to about 60% to about 80% of the total weight. However, by utilizing the here disclosed scheme, batteries may not be required to be as powerful, thereby reducing their overall size and weight of the batteries, and in turn diminishing the weight of e-readers. Moreover, by diminishing such weight considerably, e-readers can be made thinner. In other cases, previous volume used up for battery allocation, can be distributed to increase display capacity.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, we claim:

1. A method for wireless power transmission to an electronic device, comprising:
connecting a pocket-forming transmitter to a power source;
generating SW waves from a SW circuit embedded within the transmitter;
controlling the generated SW waves with a digital signal processor in the transmitter;
transmitting the SW waves through transducer elements connected to the transmitter within a predefined range; and
capturing the SW waves forming pockets of energy converging in 3-D space at a receiver with sensor elements connected to the electronic device within the predefined range to convert the pockets of energy into a DC voltage for charging or powering the electronic device.

2. The method for wireless power transmission to an electronic device within a predefined range of claim 1, wherein the transmitter and receiver include communication circuitry for transferring information between the transmitter and receiver.

3. The method for wireless power transmission to an electronic device within a predefined range of claim 2, further includes the step of communicating information between the transmitter and receiver through the communication circuitry to identify the device, a user, a battery level, a location or other such information of each electronic device within the predefined range.

4. The method for wireless power transmission to an electronic device within a predefined range of claim 1, wherein the receiver or the electronic device includes a capacitor having a storage capacity for powering the electronic device whenever the electronic device is within the predefined range of the transmitter and for powering the electronic device only for a limited predetermined period of time whenever the electronic device is out of the predefined range of the transmitter.

5. The method for wireless power transmission to an electronic device within a predefined range of claim 1, wherein the transmitter identifies each electronic device within the predefined range and delivers power to each approved electronic device through pocket-forming but disables, locks out and removes power from each electronic device when the approved electronic device is moved out of the range of the transmitter for security reasons.

6. The method for wireless power transmission to an electronic device within a predefined range of claim 1, wherein the transmitter identifies each receiver requesting power and then only powers approved electronic devices within the predefined range of the transmitter.

7. The method for wireless power transmission to an electronic device within a predefined range of claim 4, wherein the receiver and capacitor providing an operating voltage to the electronic device eliminates the need for a battery to power the electronic device within the predefined range of the transmitter.

8. The method for wireless power transmission to an electronic device within a predefined range of claim 3, wherein the communication circuitry uses standard wireless communication protocols such as Bluetooth, Wi-Fi, Zigbee or FM radio between the transmitter and receiver.

9. The method for wireless power transmission to an electronic device within a predefined range of claim 1, wherein the transducer elements in the transmitter and receiver operate in the frequency bands of 10 KHz to 50 KHz.

10. The method for wireless power transmission to an electronic device within a predefined range of claim 1, further includes the step of generating multiple pockets of energy from the pocket-forming transmitter to power or charge multiple, approved electronic devices in an educational setting within the predefined range of the transmitter.

11. The method for wireless power transmission to an electronic device within a predefined range of claim 10, wherein the electronic devices in the educational setting are tablets, electronic readers, laptops, virtual glasses or smartphones provided wireless power through pocket-forming whenever in range of the transmitter but disabled whenever outside of the predefined range of the transmitter.

12. The method for wireless power transmission to an electronic device within a predefined range of claim 1, further comprising the step of communicating between the receiver and the transmitter through the communication signals or pilot signals on conventional wireless communication protocols including Bluetooth, Wi-Fi, Zigbee or FM radio signals.

13. The method for wireless power transmission to an electronic device within a predefined range of claim 1, wherein the communication signals sent by the receiver to the transmitter provide optimum times and locations for transmitter pocket-forming and the convergence of pockets of energy in 3-D space to predetermined receivers of approved electronic devices within the predefined range of the transmitter.

14. A wireless device for transmission of power to an electronic device, comprising:
a pocket-forming transmitter for emitting SW waves to form pockets of energy converging in 3-d space connected to a power source; and
a receiver embedded or attached to the electronic device for receiving and converting the pockets of energy to a DC voltage for charging or powering the electronic device within a predefined range of the transmitter.

15. The wireless device for transmission of power to an electronic device of claim 14, wherein the transmitter and receiver include communication circuitry for transferring information between the transmitter and receiver.

16. The wireless device for transmission of power to an electronic device of claim 15, wherein the information communicated between the transmitter and receiver through the communication circuitry identifies the electronic device, a user, a battery level, a location of the electronic device or such other information for each electronic device within the predefined range.

17. The wireless device for transmission of power to an electronic device of claim 14, wherein the receiver or the electronic device includes a capacitor having a storage capacity for powering the electronic device whenever the electronic device is within the predefined range of the transmitter and for powering the electronic device only for a limited predetermined period of time whenever the electronic device is out of the predefined range of the transmitter.

18. The wireless device for transmission of power to an electronic device of claim 15, wherein the receiver and capacitor providing an operating voltage to the electronic device eliminates the need for a battery to power the electronic device within the predefined range of the transmitter.

19. An apparatus for wireless power transmission to an electronic device, comprising:
a pocket-forming transmitter having at least two or more transducer elements, at least one SW integrated circuit, at least one digital signal processor or micro-controller and a communication circuit for generating controlled SW waves to form pockets of energy consisting of constructive interference patterns of the generated SW waves to converge in 3-D space at predetermined locations; and
a rollable electronic paper display having flexible organic light emitting diodes, at least one embedded receiver and capacitor for receiving the pockets of energy converging in 3-D space at the receiver for storing charging power for the paper display.

20. The apparatus for wireless power transmission to an electronic device of claim 19, wherein the transmitter and receiver include communication circuitry utilizing Bluetooth, infrared, Wi-Fi, FM radio or Zigbee signals for the communication protocols between the receiver and the transmitter.

21. The apparatus for wireless power transmission to an electronic device of claim 19, wherein the rollable electronic paper display includes a flat panel display for use in mobiles devices, laptops, PDAs, watches and other devices requiring flat, thin displays.

22. The apparatus for wireless power transmission to an electronic device of claim 19, wherein the receiver with the capacitor replaces a need for a battery in the rollable electronic paper display.

23. The apparatus for wireless power transmission to an electronic device of claim 20, wherein the receiver in the rollable electronic paper display and the transducer elements of the transmitter operate in independent frequencies that allow a multichannel operation of pocket-forming in a single array, pair array, quad array or other suitable arrangement for powering the rollable electronic paper display whenever in range of the transmitter.

24. The apparatus for wireless power transmission to an electronic device of claim 19, wherein the receiver or the rollable electronic paper display includes a capacitor having a storage capacity for powering the rollable electronic paper display whenever the rollable electronic paper display is within the predefined range of the transmitter and for powering the rollable electronic paper display only for a limited predetermined period of time whenever the rollable electronic paper display is out of the predefined range of the transmitter.
